(19) United States
(12) Patent Application Publication
(10) Pub. No.: US 2026/0142050 A1
(43) Pub. Date: May 21, 2026

(54) EMERGENCY RELEASE DEVICE AND EMERGENCY RELEASE STRUCTURE COMPRISING SAME

(71) Applicant: KOREA ATOMIC ENERGY RESEARCH INSTITUTE, Daejeon (KR)

(72) Inventors: Kyung Jun KANG, Daejeon (KR); Sang Ji KIM, Daejeon (KR)

(21) Appl. No.: 19/119,501

(22) PCT Filed: Apr. 14, 2023
(86) PCT No.: PCT/KR2023/005104

§ 371 Date: Apr. 9, 2025

(30) Foreign Application Priority Data
Oct. 12, 2022 (KR) 10-2022-0130637
Feb. 20, 2023 (KR) 10-2023-0022054

(51) Int. Cl. G21D 3/06; B63H 21/18; G21C 3/54; G21C 15/18

(52) U.S. Cl. CPC G21D 3/06; B63H 21/18; G21C 3/54; G21C 15/18

(57) ABSTRACT

An emergency release device comprises: a release assembly configured to receive molten salt from a ship equipped with a reactor vessel in which the molten salt flows; and a valve assembly configured to, in an abnormal state where a temperature of the reactor vessel is not within a predetermined range, allow the molten salt to flow from the reactor vessel into the release assembly and to be connected to the release assembly while the molten salt flows from the reactor vessel into the release assembly.

### TECHNICAL FIELD

The present disclosure relates to an emergency release device and an emergency release structure including the same. This study is related to “Development of key technology for liquid fuel-driven nuclear heat supply module” (Project ID: 1711173760, Project Number: 522310-22) of a research project supported by the Korea Atomic Energy Research Institute's research operation fund, funded by the Ministry of Science and ICT in 2022.

### BACKGROUND ART

A molten salt reactor is a fourth-generation reactor that utilizes nuclear fuel dissolved in molten fluoride or chloride, in which salts are molten at high temperatures, as fuel and coolant for the reactor, replacing conventional solid nuclear fuel. In the event of an accident in the reactor, the temperature of the molten salt discharged from the reactor to a drain tank is about 550° C., and the molten salt that flows into the drain tank continuously releases residual heat into the interior of the containment building. This residual heat increases the temperature inside the containment building, which increases the pressure in the containment building. In addition, the molten salt that may leak outside a reactor vessel due to damage to the reactor, etc., contains nuclear fuel, so the nuclear fission products generated from the molten salt can be harmful and dangerous to humans.

In order to reduce the risk of damage caused by molten salt leaking out in the event of a reactor accident, attempts have been made to install molten salt reactors on ships and other transportation vehicles. While the safety of people living on land can be ensured when a ship or other transportation vehicle floats on the sea, if a reactor accident occurs on the ship, the crew of the ship may be in danger, and the ship may sink.

Accordingly, there is a need for a device that can flow molten salt discharged from the reactor vessel in the event of a reactor accident and safely discharge the molten salt outside the ship when the flow of the molten salt is completed.

### DETAILED DESCRIPTION OF INVENTION

### Technical Problems

In view of the above, embodiments of the present disclosure provide an emergency release device and an emergency release structure capable of, in the event of an abnormal state, causing molten salt of a reactor unit to flow to a release assembly through a valve assembly, and releasing the release assembly from a ship when the flow of molten salt into the release assembly is completed.

### Technical Solution

In accordance with one embodiment of the present disclosure, an emergency release device comprises a release assembly configured to receive molten salt from a ship equipped with a reactor vessel in which the molten salt flows; and a valve assembly configured to, in an abnormal state where a temperature of the reactor vessel is not within in a predetermined range, allow the molten salt to flow from the reactor vessel into the release assembly and to be connected to the release assembly while the molten salt flows from the reactor vessel into the release assembly.

Further, the valve assembly may include: a first channel for receiving the molten salt from the reactor vessel in the abnormal state; and a second channel detachably connected to the first channel and providing a flow path for the molten salt introduced through the first channel to flow into the release assembly.

Further, the valve assembly may further include a detachable valve module configured to flow the molten salt introduced from the first channel into the release assembly in the abnormal state, and to block flow of the molten salt once the flow of the molten salt into the release assembly is completed.

Further, the detachable valve module may include: a piston configured to open the flow path when moved to one side and close the flow path when moved to the other side; and an elastic member providing elastic force to move the piston to the other side.

Further, the detachable valve module may include: a cylinder coil that generates electromagnetic force when supplied with power from an external source; and a piston configured to open the flow path when moved to one side and close the flow path when moved to the other side, wherein the piston may be moved to the one side when electromagnetic force is generated in the cylinder coil, and moved to the other side by an elastic member when electromagnetic force is not generated in the cylinder coil.

Further, the emergency release device may further comprise a controller for controlling a direction of a current applied to the cylinder coil, wherein the piston may have magnetic properties, and the controller may control the direction of the current applied to the cylinder coil so that the cylinder coil generates electromagnetic force to move the piston away from the cylinder coil.

Further, the valve assembly may further include an attachment/detachment actuator for connecting the first channel and the second channel to each other while the molten salt flows into the release assembly, and separating the first channel and the second channel from each other once the flow of the molten salt into the release assembly is completed.

Further, the attachment/detachment actuator may include a magnetization member coil that generates electromagnetic force when supplied power from an external source, the detachable valve module may include a cylinder disposed in the second channel, and the cylinder may move toward the magnetization member coil to allow the second channel to be connected to the first channel when electromagnetic force is generated in the magnetization member coil, and may move away from the magnetization member coil to allow the second channel to be separated from the first channel when no electromagnetic force is generated in the magnetization member coil.

Further, the emergency release device may further comprise a controller for controlling the supply of power to the magnetization member coil, wherein the controller controls to supply power to the magnetization member coil while the molten salt flows into the release assembly, and controls not to supply power to the magnetization member coil once the flow of the molten salt into the release assembly is completed.

Further, the emergency release device may further comprise a controller for controlling a direction of a current applied to the magnetization member coil, wherein the detachable valve module includes: a cylinder coil that receives power from the outside to form an electromagnetic force; and a piston that has magnetic properties and moves away from the cylinder coil when electromagnetic force is generated in the cylinder coil, and wherein the controller controls the direction of the current applied to the magnetization member coil so that when the cylinder coil generates electromagnetic force to move the piston away from the cylinder coil, the magnetization member coil generates the electromagnetic force to move the magnetization member coil toward the cylinder coil.

Further, the release assembly may include a molten salt tank whose interior is maintained in a vacuum state in a normal state where the temperature of the reactor vessel is controlled within the predetermined range, and is filled with the molten salt introduced from the reactor vessel through the valve assembly in the abnormal state.

Further, the release assembly may further include a heater for heating the molten salt tank so that the molten salt filled in the molten salt tank may be maintained in a liquid state.

Further, the emergency release device may further comprise a controller for controlling the heater, wherein the controller controls the heater to heat the molten salt tank when the molten salt is filled in the molten salt tank.

Further, the release assembly may further include: an outer tank that contains gas, which expands due to heat exchange with the molten salt in the molten salt tank in the abnormal state; and a tube that receives the expanded gas from the outer tank in the abnormal state.

Further, the release assembly may further include: an injection channel providing a path for the expanded gas to flow from the outer tank to the tube; and an injection check valve arranged in the injection channel to allow the expanded gas to flow from the outer tank to the tube while preventing the gas from flowing from the tube to the outer tank.

Further, the outer tank may include: a housing tank configured to accommodate the molten salt tank and shield radiation emitted from the molten salt contained in the molten salt tank; and a gas storage tank that contains the gas.

Further, in in the outer tank, a plurality of gas storage spaces may be formed to contain the gas, and the plurality of gas storage spaces may be independently partitioned not to communicate with each other in the outer tank.

Further, an emergency release structure may comprise: a ship including a hull and a ballast tank disposed inside the hull; a reactor unit disposed inside the hull and including a reactor vessel in which molten salt flows; and an emergency release device for discharging molten salt discharged from the reactor vessel to an outside of the ship in an abnormal state where a temperature of the reactor vessel is outside in a predetermined range, wherein the emergency release device includes: a release assembly configured to receive the molten; and a valve assembly configured to, in the abnormal state, allow the molten salt to flow from the reactor vessel into the release assembly in the abnormal state and to be connected to the release assembly while the molten salt flows into the release assembly.

Further, the release assembly may be disposed in the ballast tank.

Further, the release assembly may include a molten salt tank whose interior is maintained in a vacuum state in a normal state where the temperature of the reactor vessel is controlled within the predetermined range, and is filled with the molten salt introduced from the reactor vessel through the valve assembly in the abnormal state, and wherein the reactor unit may further include: a discharge channel that provides a path for the molten salt to flow from the reactor vessel to the valve assembly; and a discharge valve disposed in the discharge channel and opened or closed to allow or block the flow of the molten salt within the discharge channel.

### Effect of Invention

According to one embodiment of the present disclosure, in the abnormal state, molten salt of the reactor unit can be flowed into the release assembly through the valve assembly, and when the flow of molten salt into the release assembly is completed, the release assembly can be released from a ship.

For example, in the abnormal state, the detachable valve module can selectively allow molten salt flowing from the reactor vessel to flow into the release assembly, and can block the flow of molten salt when the flow of molten salt into the release assembly is completed. Accordingly, even when the second channel is separated from the first channel and the release assembly is released to the outside of the ship, the molten salt does not leak out of the second channel.

In addition, the release actuator can separate the first channel and the second channel from each other once the flow of the molten salt into the release assembly is completed, and the release assembly connected to the second channel can be released to the outside of the ship. Accordingly, the release assembly floating on the sea surface can be collected, and the molten salt contained in the molten salt tank can be separately processed.

### BRIEF DESCRIPTION OF THE DRAWINGS

FIG. 1 is a cross-sectional view of an emergency release structure according to one embodiment of the present disclosure when viewed from the side.

FIG. 2 is a cross-sectional view of the emergency release structure according to one embodiment of the present disclosure when viewed from the front.

FIG. 3 is a partial enlarged view of FIG. 2.

FIG. 4 is a cross-sectional view of a valve assembly of an emergency release device according to one embodiment of the present disclosure in a normal state.

FIG. 5 is a cross-sectional view of the valve assembly of the emergency release device according to one embodiment of the present disclosure in the event of an abnormal state.

FIG. 6 is a cross-sectional view showing a state in which a first channel and a second channel of the valve assembly of the emergency release device according to one embodiment of the present disclosure are separated in the abnormal state.

FIG. 7 is a diagram of a release assembly of the emergency release device according to one embodiment of the present disclosure.

FIG. 8 is an enlarged view of the valve assembly and the release assembly of the emergency release device of FIG. 7.

### BEST MODE FOR CARRYING OUT THE INVENTION

Hereinafter, specific embodiments for implementing the technical idea of the present disclosure will be described in detail with reference to the drawings.

In addition, in describing the present disclosure, when it is determined that detailed descriptions of known configurations or functions may obscure the gist of the present disclosure, the detailed descriptions will be omitted.

Moreover, it should be understood that when a component is referred to as being ‘connected to’, ‘supported by’, ‘supplied to’, ‘transferred to’ or ‘contacted with’ another component, it may be directly connected to, supported by, supplied to, transferred to or contacted with another component, but other components may exist between the components.

The terms used in the present specification are only used for describing the specific embodiments and are not intended to limit the present disclosure. Singular expressions include plural expressions unless the context clearly indicates otherwise.

In addition, in the present specification, expressions such as upper, lower, side, etc. are described based on the drawings, and it is made clear in advance that they may be expressed differently if the direction of the object is changed. For the same reason, some components in the accompanying drawings are exaggerated, omitted, or schematically illustrated, and the size of each component does not entirely reflect the actual size.

Further, terms including ordinal numbers, such as first, second, etc., may be used to describe various components, but the components are not limited by these terms. These terms are only used to distinguish one component from another.

The meaning of “including” used in the present specification specifies specific features, regions, integers, steps, operations, elements and/or components, and does not exclude the presence or addition of other specific features, regions, integers, steps, operations, elements, components, and/or groups.

In the present specification, “normal state” refers to a state in which the temperature of a reactor vessel 21 is controlled within a predetermined range by the control of a controller 300, meaning that the nuclear reaction inside the reactor vessel 21 is controllable. In addition, “abnormal state” refers to a state in which the temperature of the reactor vessel 21 is not controlled by the controller 300, and may mean an emergency state such as various failures or power supply interruption.

Hereinafter, a specific configuration of an emergency release structure 1 according to one embodiment of the present disclosure will be described with reference to the drawings.

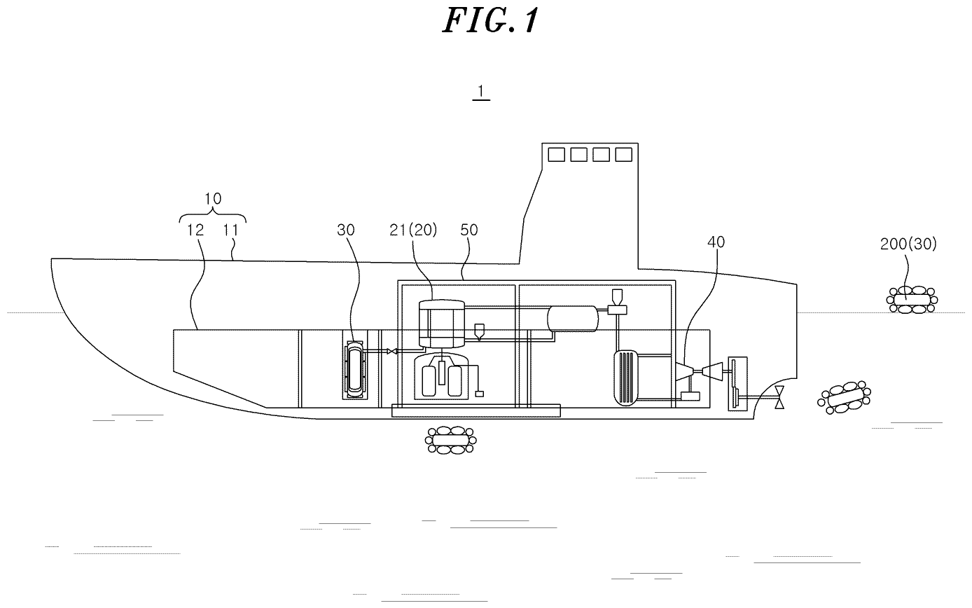

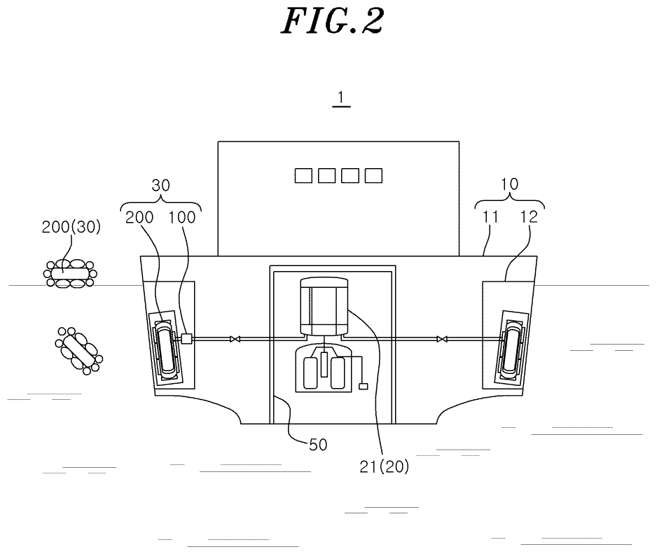

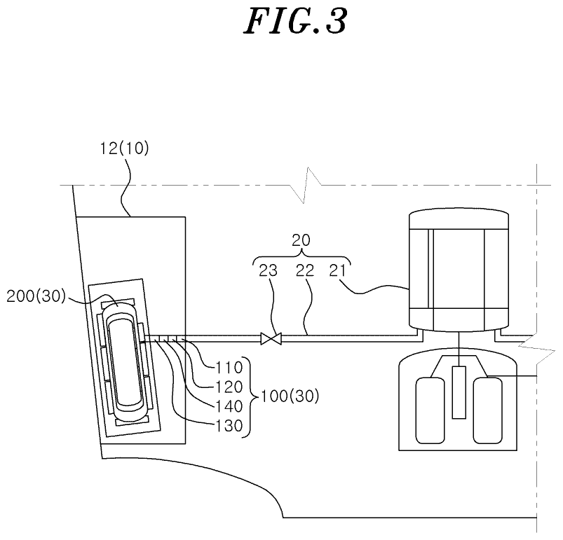

Referring to FIGS. 1 to 3, in the present embodiment, the emergency release structure 1 is capable of causing molten salt (not shown) of a reactor unit 20 to flow to a release assembly 200 through a valve assembly 100 in an abnormal state, and releasing the release assembly 200 from a ship 10 when the flow of the molten salt into the release assembly 200 is completed. The emergency release structure 1 may include a ship 10, a reactor unit 20, an emergency release device 30, an operating device 40, and a containment case 50.

The ship 10 may be a structure that can float on the sea. The ship 10 may include a hull 11 and a ballast tank 12.

The hull 11 refers to the body of the ship 10. The reactor unit 20, the emergency release device 30, the operating device 40, and the containment case 50 may be accommodated in the hull 11. In addition, the ballast tank 12 may be disposed inside the hull 11.

The ballast tank 12 can contain fluid (ballast water) to maintain the stability of the hull 11. The ballast tank 12 may be disposed at side and bottom portions in the hull 11. In addition, a release assembly 200 of the emergency release device 30, which will be described later, may be disposed inside the ballast tank 12.

The reactor unit 20 may be a molten salt reactor (MSR) that utilizes molten salt. In addition, the molten salt may be fuel or coolant for a reactor in which nuclear fuel is dissolved in molten fluoride or chloride, in which salts are molten at high temperature. The reactor unit 20 may be disposed inside the hull 11. Further, the reactor unit 20 may be connected to the emergency release device 30 and the operating device 40, and may be disposed in the containment case 50. The reactor unit 20 may include a reactor vessel 21, a discharge channel 22, and a discharge valve 23.

The reactor vessel 21 may contain molten salt therein. The reactor vessel 21 may be configured to allow the molten salt to be discharged into the discharge channel 22. For example, when the reactor is in a normal state in which it is operating normally, the molten salt in the reactor vessel 21 can be prevented from being discharged into the discharge channel 22. Further, when the reactor is in an abnormal state in which it is not operating normally, the molten salt in the reactor vessel 21 can be discharged into the discharge channel 22. Meanwhile, a core in which a nuclear reaction occurs may be placed inside the reactor vessel 21.

In the abnormal state, the discharge channel 22 may provide a path for the molten salt in the reactor vessel 21 to flow to a first channel 110 of the emergency release device 30, which will be described later. For example, one side of the discharge channel 22 may be connected to the reactor vessel 21, and the other side may be connected to the first channel 110 of the emergency release device 30.

The discharge valve 23 may be disposed in the discharge channel 22 and can be opened or closed to allow or block the flow of molten salt within the discharge channel 22. For example, the discharge valve 23 is closed in the normal state and opened in the abnormal state so that the molten salt discharged from the reactor vessel 21 can flow through the discharge channel 22 to the first channel 110 of the emergency release device 30. Meanwhile, the discharge valve 23 may be connected to the controller 300 which controls opening or closing of the discharge valve 23.

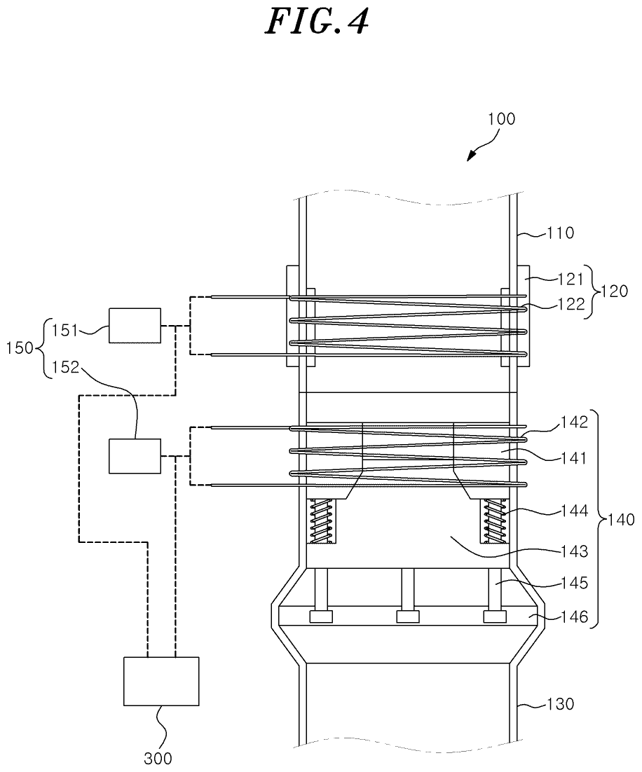

Referring to FIGS. 4 to 6, in the abnormal state, the emergency release device 30 can allow the molten salt in the reactor vessel 21 to flow into the release assembly 200 through the valve assembly 100, and release the release assembly 200 from the ship 10 when the flow of the molten salt into the release assembly 200 is completed. The emergency release device 30 may include the valve assembly 100, the release assembly 200, and the controller 300.

In the abnormal state, the valve assembly 100 can cause the molten salt to flow from the reactor vessel 21 into the release assembly 200, and separate the release assembly 200 in which the flow of the molten salt is completed. The valve assembly 100 may include a first channel 110, an attachment/detachment actuator 120, a second channel 130, a detachable valve module 140, and a battery 150.

The first channel 110 can receive molten salt from the reactor vessel 21 in the abnormal state. For example, in the abnormal state, molten salt can flow into the first channel 110 from the reactor vessel 21 through the discharge channel 22. In the first channel 110, a flow path through which the introduced molten salt flows may be formed. The first channel 110 may be detachably connected to the second channel 130 by the attachment/detachment actuator 120, and a detailed description thereof will be provided later. Meanwhile, in a state where the first channel 110 is connected to the second channel 130 by the attachment/detachment actuator 120, the molten salt introduced into the first channel 110 may selectively flow into the second channel 130 through the detachable valve module 140.

The attachment/detachment actuator 120 can connect the first channel 110 and the second channel 130 to each other while the molten salt flows to the release assembly 200, and can separate the first channel 110 and the second channel 130 from each other when the flow of the molten salt to the release assembly 200 is completed. The attachment/detachment actuator 120 may be disposed in the first channel 110. The attachment/detachment actuator 120 can connect the first channel 110 and the second channel 130 to each other while the molten salt introduced from the reactor vessel 21 flows to the release assembly 200 through the first channel 110 and the second channel 130. In addition, the attachment/detachment actuator 120 can separate the first channel 110 and the second channel 130 from each other once the flow of the molten salt introduced from the reactor vessel 21 to the release assembly 200 through the first channel 110 and the second channel 130 has been completed. The attachment/detachment actuator 120 may include a magnetization member 121 and a magnetization member coil 122. The magnetization member 121 may support the magnetization member coil 122. The magnetization member 121 may be placed at one end of the first channel 110. The magnetization member 121 may be formed of a conductive member such as metal.

The magnetization member coil 122 can generate electromagnetic force when supplied with power from an external source. For example, the magnetization member coil 122 may be connected to a first battery 151 and receive power therefrom to generate electromagnetic force. When power is supplied to the magnetization member coil 122 to generate electromagnetic force, a cylinder 141 of the detachable valve module 140, which will be described later, can be moved to be adjacent to the magnetization member coil 122 by the electromagnetic force. In other words, when the cylinder 141 is positioned adjacent to the magnetization member coil 122, the second channel 130 to which the cylinder 141 is connected can be connected in communication with the first channel 110. Further, when power is not supplied to the magnetization member coil 122, the cylinder 141 of the detachable valve module 140 can be moved away from the magnetization member coil 122. In other words, the second channel 130 to which the cylinder 141 is connected can be separated from the first channel 110.

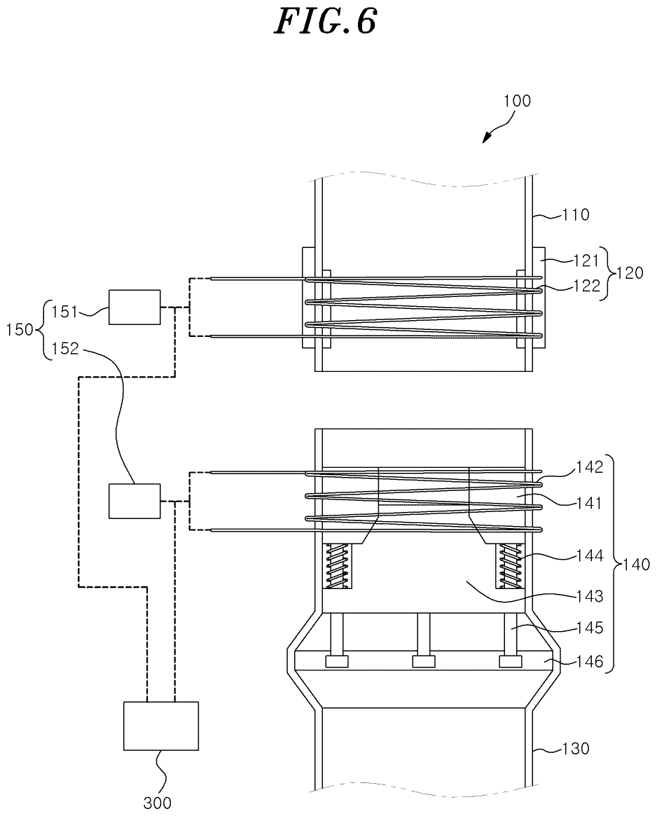

The direction of the current applied to the magnetization member coil 122 may be controlled by the controller 300. For example, when the current flows in one direction (to the right in FIG. 4) through the magnetization member coil 122, an S pole can be formed on one side (lower side in FIG. 4) and an N pole can be formed on the other side (upper side in FIG. 4) of the magnetization member coil 122 according to Ampere's right-hand rule. While a current flows in one direction (to the right in FIG. 4) through a cylinder coil 142 of the detachable valve module 140, which will be described later, and an N pole is formed on the other side (upper side in FIG. 4) of the cylinder coil 142, when a current flows in one direction to the magnetization member coil 122 by the controller 300, an S pole can be formed on one side (lower side in FIG. 4) of the magnetization member coil 122. In this case, an attractive force is generated between the magnetization member coil 122 and the cylinder coil 142 to cause the first channel 110 and the second channel 130 to be connected to each other. In other words, the direction of the current flowing in the magnetization member coil 122 can be controlled by the controller 300 to allow the molten salt to flow to the release assembly 200 through the first channel 110 and the second channel 130 in the event of an abnormal state. When the flow of the molten salt to the release assembly 200 is completed, the current can be controlled not to be applied to the magnetization member coil 122, and the first channel 110 and the second channel 130 can be separated from each other (FIG. 6). The magnetization member coil 122 may be wrapped around an outer peripheral surface of the magnetization member 121.

The second channel 130 may provide a flow path for the molten salt introduced through the first channel 110 to flow to the release assembly 200. The detachable valve module 140 may be disposed in the second channel 130, and the second channel 130 may be selectively connected to or separated from the first channel 110 by the attachment/detachment actuator 120 disposed in the first channel 110. For example, when power is supplied to the magnetization member coil 122 of the attachment/detachment actuator 120 disposed in the first channel 110 and electromagnetic force is generated, the cylinder 141 of the detachable valve module 140 moves toward the magnetization member coil 122, so that the second channel 130 can be connected to the first channel 110 to be in communication with each other. Further, when no power is supplied to the magnetization member coil 122 and thus electromagnetic force is not generated, the cylinder 141 may be moved away from the magnetization member coil 122 so that the second channel 130 may be separated from the first channel 110. The release assembly 200 may be connected to the second channel 130, and when the second channel 130 is separated from the first channel 110, the release assembly 200 may be released to the outside of the ship 10.

The detachable valve module 140 may be configured to selectively allow the molten salt flowing from the first channel 110 to flow to the release assembly 200 in the event of an abnormal state, and block the flow of the molten salt within the second channel 130 once the flow of the molten salt to the release assembly 200 is completed. The detachable valve module 140 may be disposed in the second channel 130. The detachable valve module 140 may include a cylinder 141, a cylinder coil 142, a piston 143, an elastic member 144, a piston guide 145, and an expansion portion 146.

The cylinder 141 is disposed in the second channel 130, and a cylinder hole 141a into which the piston 143 can be inserted may be formed in the cylinder 141. The cylinder hole 141a can be closed when the piston 143 is inserted therein, and can be opened when the piston 143 is moved to separate therefrom. When the cylinder hole 141a is opened, a flow path through which the molten salt introduced into the second channel 130 flows may be formed in the cylinder hole 141a. In other words, when the piston 143 is moved to separate from the cylinder 141, the molten salt introduced into the second channel 130 can flow within the second channel 130 through the cylinder hole 141a. Meanwhile, when the piston 143 is formed to be disposed in an opening of the second channel 130 with a diameter corresponding to an inner diameter of the second channel 130, the cylinder 141 may not be installed in the second channel 130.

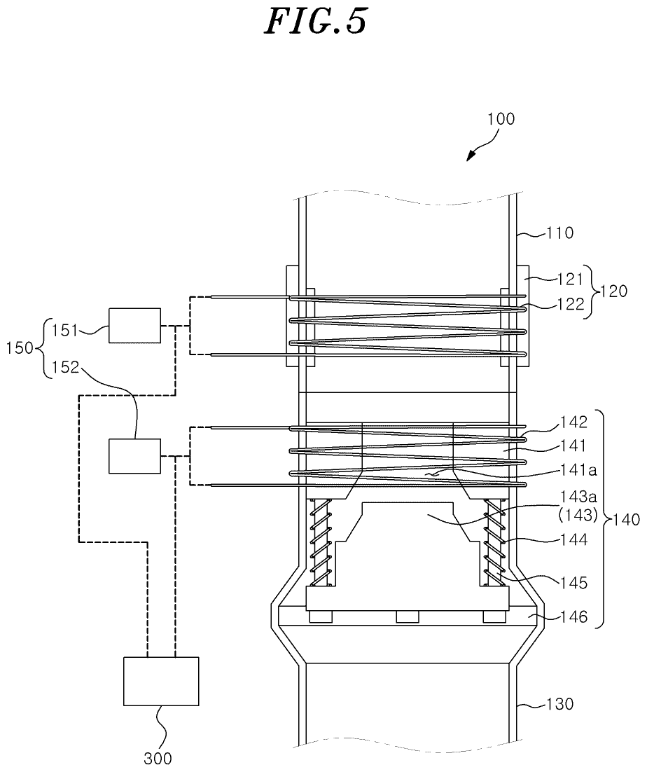

The cylinder coil 142 can generate electromagnetic force when supplied with power from an external source. In the abnormal state, when power is supplied to the cylinder coil 142 and electromagnetic force is generated, the piston 143 can move in a direction away from the cylinder coil 142. For example, the piston 143 may have magnetic properties, and in case that a magnetic forming portion 143a of the piston 143, which will be described later, is formed as an S pole, when a current flows in one direction (to the right in FIG. 5) through the cylinder coil 142, an N pole can be formed on the other side (upper side in FIG. 5) of the cylinder coil 142 and an S pole can be formed on one side (lower side in FIG. 5) by Ampere's right-hand rule. Accordingly, a repulsive force is generated between the cylinder coil 142 and the piston 143, so that the piston 143 can move away from the cylinder coil 142. In this case, the cylinder hole 141a of the cylinder 141 is opened, so that the molten salt can flow into the release assembly 200 through the second channel 130.

Once the flow of molten salt into the release assembly 200 is completed, the controller 300 controls to supply no power to the cylinder coil 142, and the piston 143 can be moved toward the cylinder 141 by the elastic member 144 (see FIG. 6). As the piston 143 is inserted into the interior of the cylinder 141 and the cylinder hole 141a of the cylinder 141 is closed, the flow of molten salt out of the second channel 130 can be blocked. Accordingly, even if the second channel 130 is separated from the first channel 110 and the release assembly 200 is released to the outside of the ship 10, the molten salt does not leak out of the second channel 130.

The direction of the current applied to the cylinder coil 142 can be controlled by the controller 300. For example, when the magnetic forming portion 143a of the piston 143 is formed as an S pole, the controller 300 can control the current to flow in one direction (to the right in FIG. 5) through the cylinder coil 142 in the abnormal state. In this case, an N pole is formed on the other side (upper side in FIG. 5) of the cylinder coil 142 and an S pole is formed on one side (lower side in FIG. 5), so that a repulsive force is generated between the cylinder coil 142 and the piston 143, causing the piston 143 to move away from the cylinder coil 142. In addition, when the magnetic forming portion 143a of the piston 143 is formed as an N pole, the controller 300 can control the current to flow in the other direction (to the left in FIG. 5) through the cylinder coil 142 in the abnormal state. In this case, an S pole is formed on the other side (upper side in FIG. 5) of the cylinder coil 142 and an N pole is formed on one side (lower side in FIG. 5), so that a repulsive force is generated between the cylinder coil 142 and the piston 143, causing the piston 143 to move away from the cylinder coil 142.

The piston 143 can be moved to be spaced apart from or inserted into the cylinder hole 141a of the cylinder 141. The piston 143 may have magnetic properties and may be moved to be spaced apart from the cylinder hole 141a by the electromagnetic force generated by the cylinder coil 142. For example, the magnetic forming portion 143a with magnetic properties may be provided on the other side (upper side in FIG. 5) of the piston 143 adjacent to the cylinder 141. In case that the magnetic forming portion 143a is formed as an S pole, when current flows in one direction (to the right in FIG. 5) through the cylinder coil 142, an N pole can be formed on the other side (upper side in FIG. 5) of the cylinder coil 142 and an S pole can be formed on one side (lower side in FIG. 5). Accordingly, a repulsive force is generated between the cylinder coil 142 and the piston 143, causing the piston 143 to move away from the cylinder coil 142. In this case, the cylinder hole 141a of the cylinder (141) is opened, so that the molten salt can flow into the release assembly 200 through the second channel 130.

The piston 143 can be moved to be inserted into the cylinder hole 141a by the elastic force of the elastic member (144. For example, when no power is supplied to the cylinder coil 142 and thus no electromagnetic force is generated, the piston 143 can be moved to be inserted into the cylinder hole 141a by the elastic member 144 with the elastic force to move the piston 143 toward the cylinder hole 141a of the cylinder 141. In this case, the cylinder hole 141a can be closed and the flow of the molten salt within the second channel 130 can be blocked. Meanwhile, a piston guide 145 is provided to extend through one side end portion of the piston 143, and the piston 143 can be guided to move to one side or the other side by the piston guide 145.

Meanwhile, the piston 143 may be configured to open the flow path of the second channel 130 when moving to one side, and close the flow path of the second channel 130 when moving to the other side. When the piston 143 is formed to be disposed in the opening of the second channel 130 with a diameter corresponding to the inner diameter of the second channel 130, the cylinder 141 may not be installed in the second channel 130. In this case, the piston 143 may be moved to directly open or close the flow path of the second channel 130 by an attractive or repulsive force applied by the cylinder coil 142.

The elastic member 144 can provide elastic force to move the piston 143 toward the cylinder hole 141a of the cylinder 141. One side of the elastic member 144 may be in contact with the piston 143, and the other side of the elastic member 144 may be in contact with the cylinder 141. In addition, the elastic member 144 may be arranged to wrap around the piston guide 145 to be guided by the piston guide 145 as it stretches or contracts. The elastic member 144 may include a tension spring that provides elastic force to move the piston 143 toward the cylinder hole 141a of the cylinder 141.

The piston guide 145 can guide the movement of the piston 143. The piston guide 145 may be formed to penetrate one side end portion of the piston 143 and may be provided in multiple pieces. In addition, the elastic member 144 may be arranged around the piston guide 145 so that the stretching or contraction of the elastic member 144 can be guided by the piston guide 145.

The expansion portion 146 can expand the inner diameter of the second channel 130. The expansion portion 146 may be provided within the second channel 130. The molten salt introduced into the second channel 130 flows into the second channel 130 through the cylinder hole 141a of the cylinder 141. In this case, if the diameter of one side end portion of the piston 143 is formed relatively large to correspond to the diameter of the cylinder 141 as shown in the drawing, the molten salt can flow along an inner peripheral surface of the second channel 130 expanded by the expansion portion 146. However, if the diameter of one side end portion of the piston 143 is formed relatively small than the inner diameter of the cylinder 141, the molten salt can flow along an outer peripheral surface of the piston 143, and thus the expansion portion 146 may not be provided in the second channel 130. Meanwhile, the expansion portion 146 may support one end of a guide pin.

The battery 150 may include a first battery 151 for supplying power to the magnetization member coil 122 and a second battery 152 for supplying power to the cylinder coil 142. Meanwhile, the direction of the current applied to the magnetization member coil 122 and the cylinder coil 142 by the first battery 151 and the second battery 152 may be controlled by the controller 300.

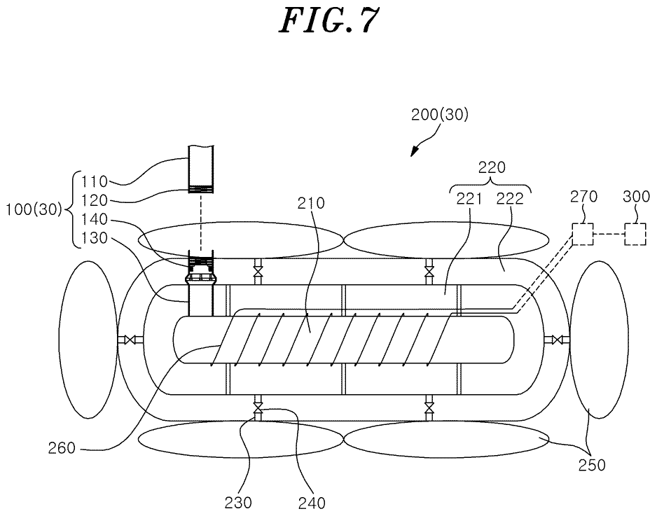

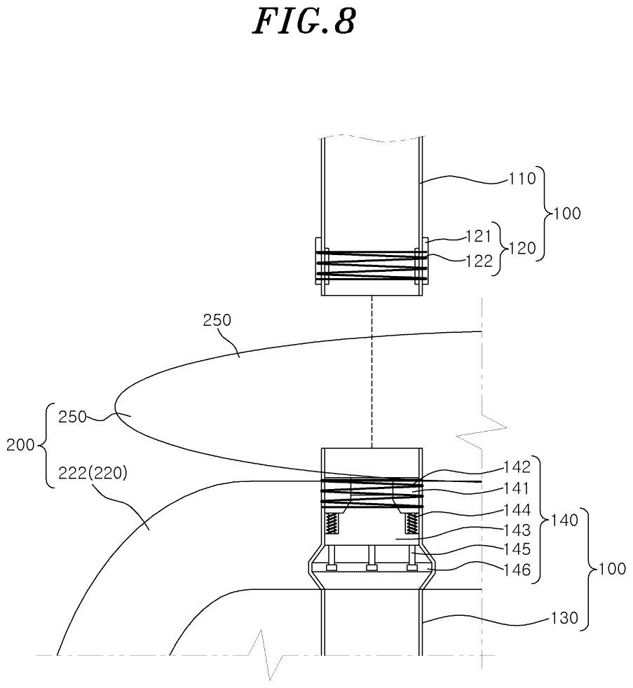

Referring to FIGS. 7 and 8, the release assembly 200 is configured to receive molten salt from the reactor vessel 21 through which molten salt flows, and once the flow of the molten salt into the release assembly 200 is completed, the release assembly 200 can be released to the outside of the ship 10 by the valve assembly 100. For example, once the flow of the molten salt into the release assembly 200 is completed, the first channel 110 and the second channel 130 are separated by the attachment/detachment actuator 120 and the detachable valve module 140, and the release assembly 200 connected to the second channel 130 can be released to the outside of the ship 10 and float on the sea surface. Meanwhile, the release assembly 200 may be disposed in the ballast tank 12. Accordingly, radiation that may be generated from the molten salt while the molten salt flows into the release assembly 200 in the abnormal state can be prevented from being emitted outside of the ballast tank 12. The release assembly 200 may include a molten salt tank 210, an outer tank 220, an injection channel 230, an injection check valve 240, a tube 250, a heater 260, and a power supply unit 270.

The molten salt tank 210 may be maintained in a vacuum state in the normal state. Meanwhile, vacuum is defined as a broad concept including a negative pressure state where the pressure is lower than atmospheric pressure. In addition, the molten salt tank 210 may be filled with molten salt flowing from the reactor vessel 21 through the valve assembly 100 in the abnormal state. For example, in the abnormal state, while the first channel 110 and the second channel 130 are connected to each other by the attachment/detachment actuator 120 and the detachable valve module 140, when power is supplied to the cylinder coil 142 to cause the piston 143 to move away from the cylinder 141, the molten salt can flow into the molten salt tank 210 through the first channel 110 and the second channel 130. In this case, the molten salt can be introduced into the molten salt tank 210 with relatively low pressure through the second channel 130.

A heater 260 may be wrapped around an outer peripheral surface of the molten salt tank 210, and the molten salt tank 210 and the molten salt inside the molten salt tank 210 may be heated by the heater 260. When the molten salt is heated, the molten salt may be maintained in a liquid state. When the release assembly 200 is released to the outside of the ship 10 and floats on the sea surface, the molten salt inside the molten salt tank 210 may gradually cool and solidify. If the molten salt solidifies, it may become difficult to recover the molten salt inside the molten salt tank 210. Accordingly, when the molten salt tank 210 and the molten salt are heated by the heater 260 to maintain the molten salt in a liquid state, it may become easy to recover the molten salt from the molten salt tank 210. The liquid molten salt can be recovered from the molten salt tank 210 to the outside through the second channel 130.

The outer tank 220 may accommodate the molten salt tank 210 to surround it. The outer tank 220 may include a gas storage tank 221 and a housing tank 222.

The gas storage tank 221 may contain gas that expands by exchanging heat with the molten salt in the molten salt tank 210. The gas storage tank 221 may surround the molten salt tank 210 to contact an outer peripheral surface of the molten salt tank 210. Accordingly, the heat of the relatively high temperature molten salt can be transferred to the gas storage tank 221 through the molten salt tank 210. When the relatively high temperature heat is transferred to the gas in the gas storage tank 221, the gas can be expanded. The expanded gas can flow into the tube 250 through the injection channel 230. This gas may include helium, which can expand when heated.

The gas storage tank 221 may have a plurality of gas storage spaces for containing gas. The plurality of gas storage spaces may be independently partitioned not to communicate with each other. A plurality of injection channels 230 may be connected to the plurality of independently partitioned gas storage spaces. In addition, a plurality of gas storage tanks 221 may be provided. The plurality of gas storage tanks 221 may be independently partitioned not to communicate with each other, and a plurality of injection channels 230 may be connected to the plurality of independently partitioned gas storage tanks 221.

The housing tank 222 may be configured to accommodate the molten salt tank 210 and the gas storage tank 221, and shield radiation generated from molten salt contained in the molten salt tank 210. For example, a radiation shielding material may be accommodated inside the housing tank 222.

The injection channel 230 may provide a path for the expanded gas to flow from the gas storage tank 221 to the tube 250. A plurality of injection channels 230 may be provided, and one ends of the plurality of injection channels 230 may be connected to the plurality of independently partitioned gas storage spaces or the plurality of independently partitioned gas storage tanks 221, and the other ends may be connected to the plurality of tubes 250.

The injection check valve 240 may be arranged in the injection channel 230 to allow the expanded gas to flow from the gas storage tank 221 to the tube 250 while preventing the gas from flowing from the tube 250 to the gas storage tank 221. For example, the injection check valve 240 may include a check valve configured to allow the expanded gas to flow only from the gas storage tank 221 to the tube 250. A plurality of injection check valves 240 may be provided to be arranged in the plurality of injection channels 230.

In the abnormal state, expanded gas from the gas storage tank 221 may be introduced into the tube 250 through the injection channel 230. When gas is introduced into the tube 250, buoyancy is generated, allowing the release assembly 200 to float on the sea surface. The tube 250 may be configured to remain relatively contracted in the normal state, and expand when gas is introduced therein from the gas storage tank 221 through the injection channel 230. A plurality of tubes 250 may be provided, and may be connected to the plurality of injection channels 230.

The heater 260 can heat the molten salt tank 210 so that the molten salt filled in the molten salt tank 210 is maintained in a liquid state. The heater 260 may include a heating coil that generates heat when power is supplied thereto. The heater 260 may be extended to wrap around the outer peripheral surface of the molten salt tank 210.

The power supply unit 270 can supply power to the heater 260. The power supply unit 270 may be connected to the controller 300 and its operation can be controlled. For example, the power supply unit 270 can be controlled by the controller 300 to heat the molten salt tank 210 when the reactor vessel 21 is in the abnormal state and molten salt is filled in the molten salt tank 210.

Referring again to FIGS. 4 to 6, the controller 300 can control supply of power to the magnetization member coil 122. For example, in the abnormal state, when the controller 300 controls to supply power to the magnetization member coil 122, electromagnetic force is generated in the magnetization member coil 122, so that the cylinder 141 can move adjacent to the magnetization member coil 122, and the first channel 110 and the second channel 130 can be connected to each other. Further, when the controller 300 controls to supply no power to the magnetization member coil 122, the cylinder 141 can move away from the magnetization member coil 122, and the first channel 110 and the second channel 130 can be separated from each other.

In addition, the controller 300 can control the direction of the current applied to the magnetization member coil 122. For example, in the abnormal state, when the controller 300 controls the current to flow in one direction through the magnetization member coil 122, an attractive force is generated between the magnetization member coil 122 and the cylinder coil 142, so that the first channel 110 and the second channel 130 can be connected to each other. The controller 300 can control supply of power to the cylinder coil 142. For example, in the abnormal state, when the controller 300 controls to supply power to the cylinder coil 142, the piston 143 can move in a direction away from the cylinder coil 142, and the cylinder hole 141a of the cylinder 141 can be opened so that the molten salt can flow within the second channel 130. Further, when the controller 300 does not supply power to the cylinder coil 142, the piston 143 can move toward the cylinder coil 142 by the elastic member 144, and the cylinder hole 141a of the cylinder 141 can be closed so that the molten salt can be prevented from leaking outside the second channel 130.

In addition, the controller 300 can control the direction of the current applied to the cylinder coil 142. For example, when the magnetic forming portion 143a of the piston 143 is formed as an S pole, the controller 300 can control the current to flow in one direction through the cylinder coil 142 in the abnormal state. Further, when the magnetic forming portion 143a of the piston 143 is formed as an N pole, the controller 300 can control the current to flow in the other direction through the cylinder coil 142 in the abnormal state. In both of the above cases, a repulsive force is generated between the cylinder coil 142 and the piston 143 to cause the piston 143 to move away from the cylinder coil 142, and the cylinder hole 141a of the cylinder 141 is opened so that the molten salt can flow within the second channel 130.

The controller 300 can control the discharge valve 23 to block the discharge valve 23 in the normal state and open the discharge valve 23 in the abnormal state. When the controller 300 opens the discharge valve 23 in the abnormal state, the molten salt can flow from the reactor vessel 21 to the first channel 110 through the discharge channel 22.

In addition, the controller 300 can control the power supply unit 270 to heat the molten salt tank 210 when the molten salt is filled in the molten salt tank 210 in the abnormal state. Meanwhile, the controller 300 may be implemented by a computing device including a microprocessor, a memory, etc., and the implementation method is obvious to those skilled in the art, so a detailed description thereof will be omitted.

The operating device 40 may include a steam generator connected to the reactor unit 20 and a turbine that operates using steam supplied from the steam generator. The turbine may be configured to rotate a propeller of the ship 10. A part of the operating device 40 may be disposed within the containment case 50.

The containment case 50 may accommodate the reactor unit 20. The containment case 50 may be configured to shield radiation emitted from molten salt contained within the molten salt tank 210. A plurality of containment cases 50 may be provided and may accommodate a part of the operating device 40.

Hereinafter, the operation and effects of the emergency release structure 1 having the configuration described above will be described.

In the normal state, molten salt flows within the reactor vessel 21 of the reactor unit 20, and the molten salt is not discharged outside the reactor vessel 21. Meanwhile, in the normal state, power is supplied to the magnetization member coil 122 of the attachment/detachment actuator 120 to cause the cylinder 141 of the detachable valve module 140 to move and be positioned adjacent to the magnetization member coil 122, so that the first channel 110 and the second channel 130 can be connected to each other. In this case, no power is supplied to the cylinder coil 142, so that the piston 143 is kept in a position that closes the cylinder hole 141a of the cylinder 141.

In the abnormal state, the discharge valve 23 is opened and the molten salt flows from the reactor vessel 21 through the discharge channel 22 into the first channel 110 of the valve assembly 100.

In the abnormal state, the attachment/detachment actuator 120 can connect the first channel 110 and the second channel 130 to each other while the molten salt introduced from the reactor vessel 21 flows to the release assembly 200 through the first channel 110 and the second channel 130. For example, in the abnormal state, when the controller 300 applies power to the magnetization member coil 122, electromagnetic force is generated in the magnetization member coil 122, causing the cylinder 141 to move adjacent to the magnetization member coil 122, so that the first channel 110 and the second channel 130 can be connected in communication with each other.

In the abnormal state, the detachable valve module 140 can selectively allow the molten salt introduced from the first channel 110 to flow to the release assembly 200, and can block the flow of the molten salt once the flow of the molten salt to the release assembly 200 is completed. For example, when the controller 300 applies power to the cylinder coil 142 in the abnormal state, the piston 143 can move away from the cylinder coil 142, and the cylinder hole 141a of the cylinder 141 can be opened so that the molten salt can flow into the release assembly 200 through the second channel 130. Once the flow of the molten salt to the release assembly 200 is completed, the detachable valve module 140 can block the flow of the molten salt. For example, when the controller 300 does not supply power to the cylinder coil 142, the piston 143 can be moved toward the cylinder coil 142 by the elastic member 144. In this case, the cylinder hole 141a of the cylinder 141 can be closed to prevent molten salt from flowing out of the second channel 130. Accordingly, even if the second channel 130 is separated from the first channel 110 and the release assembly 200 is released to the outside of the ship 10, the molten salt does not leak out of the second channel 130.

The attachment/detachment actuator 120 can separate the first channel 110 and the second channel 130 from each other once the flow of the molten salt into the release assembly is completed. For example, when the controller 300 does not supply power to the magnetization member coil 122, the cylinder 141 can be moved away from the magnetization member coil 122, and the first channel 110 and the second channel 130 can be separated from each other. Accordingly, the release assembly 200 connected to the second channel 130 can be released to the outside of the ship 10.

The release assembly 200 can be released to the outside of the ship 10 once the introduction of molten salt is completed by the valve assembly 100. For example, once the introduction of molten salt into the release assembly 200 is completed, the first channel 110 and the second channel 130 are separated by the attachment/detachment actuator 120 and the detachable valve module 140, and the release assembly 200 connected to the second channel 130 can be released to the outside of the ship 10 to float on the sea surface. The release assembly 200 floating on the sea surface can be collected, and the molten salt contained in the molten salt tank 210 can be processed separately.

Although the embodiments of the present disclosure have been described as specific embodiments, this is merely an example, and the present disclosure should be construed as having the broadest scope according to the technical idea disclosed herein without being limited thereto. Those skilled in the art may implement a pattern of a shape not indicated herein by combining/substituting the disclosed embodiments, but this also does not deviate from the scope of the present disclosure. In addition, those skilled in the art may easily change or modify the disclosed embodiments based on the present specification, and it is clear that such changes or modifications also fall within the scope of the present disclosure.

1. An emergency release device comprising:
a release assembly configured to receive molten salt from a ship equipped with a reactor vessel in which the molten salt flows; and
a valve assembly configured to, in an abnormal state where a temperature of the reactor vessel is not within a predetermined range, allow the molten salt to flow from the reactor vessel into the release assembly and to be connected to the release assembly while the molten salt flows from the reactor vessel into the release assembly.

2. The emergency release device of claim 1, wherein the valve assembly includes
a first channel for receiving the molten salt from the reactor vessel in the abnormal state; and
a second channel detachably connected to the first channel and providing a flow path for the molten salt introduced through the first channel to flow into the release assembly.

3. The emergency release device of claim 2, wherein the valve assembly further includes a detachable valve module configured to flow the molten salt introduced from the first channel into the release assembly in the abnormal state, and to block flow of the molten salt between the first channel and the release assembly once the flow of the molten salt into the release assembly is completed.

4. The emergency release device of claim 3, wherein the detachable valve module include:
a piston configured to open the flow path when moved to one side and close the flow path when moved to the other side; and
an elastic member providing elastic force to move the piston to the other side.

5. The emergency release device of claim 3, wherein the detachable valve module includes:
a cylinder coil that generates electromagnetic force when supplied with power from an external source; and
a piston configured to open the flow path when moved to one side and close the flow path when moved to the other side,
wherein the piston is moved to the one side when electromagnetic force is generated in the cylinder coil, and moved to the other side by an elastic member when electromagnetic force is not generated in the cylinder coil.

6. The emergency release device of claim 5, further comprising a controller for controlling a direction of a current applied to the cylinder coil,
wherein the piston has magnetic properties, and
the controller controls the direction of the current applied to the cylinder coil so that the cylinder coil generates electromagnetic force to move the piston away from the cylinder coil.

7. The emergency release device of claim 3, wherein the valve assembly further includes an attachment/detachment actuator for connecting the first channel and the second channel to each other while the molten salt flows into the release assembly, and separating the first channel and the second channel from each other once the flow of the molten salt into the release assembly is completed.

8. The emergency release device of claim 7, wherein the attachment/detachment actuator includes a magnetization member coil that generates electromagnetic force when supplied power from an external source,
the detachable valve module includes a cylinder disposed in the second channel, and
the cylinder moves toward the magnetization member coil to allow the second channel to be connected to the first channel when electromagnetic force is generated in the magnetization member coil, and moves away from the magnetization member coil to allow the second channel to be separated from the first channel when no electromagnetic force is generated in the magnetization member coil.

9. The emergency release device of claim 8, further comprising a controller for controlling the supply of power to the magnetization member coil,
wherein the controller controls to supply power to the magnetization member coil while the molten salt flows into the release assembly, and controls not to supply power to the magnetization member coil once the flow of the molten salt into the release assembly is completed.

10. The emergency release device of claim 8, further comprising a controller for controlling a direction of a current applied to the magnetization member coil,
wherein the detachable valve module includes:
a cylinder coil that receives power from the outside to form an electromagnetic force; and
a piston that has magnetic properties and moves away from the cylinder coil when electromagnetic force is generated in the cylinder coil, and
wherein the controller controls the direction of the current applied to the magnetization member coil so that when the cylinder coil generates electromagnetic force to move the piston away from the cylinder coil, the magnetization member coil generates the electromagnetic force to move the magnetization member coil toward the cylinder coil.

11. The emergency release device of claim 1, wherein the release assembly includes a molten salt tank whose interior is maintained in a vacuum state in a normal state where the temperature of the reactor vessel is controlled within the predetermined range, and is filled with the molten salt introduced from the reactor vessel through the valve assembly in the abnormal state.

12. The emergency release device of claim 11, wherein the release assembly further includes a heater for heating the molten salt tank so that the molten salt filled in the molten salt tank is maintained in a liquid state.

13. The emergency release device of claim 12, further comprising a controller for controlling the heater,
wherein the controller controls the heater to heat the molten salt tank when the molten salt is filled in the molten salt tank.

14. The emergency release device of claim 11, wherein the release assembly further includes:
an outer tank that contains gas, which expands due to heat exchange with the molten salt in the molten salt tank in the abnormal state; and
a tube that receives the expanded gas from the outer tank in the abnormal state.

15. The emergency release device of claim 14, wherein the release assembly further includes:
an injection channel providing a path for the expanded gas to flow from the outer tank to the tube; and
an injection check valve arranged in the injection channel to allow the expanded gas to flow from the outer tank to the tube while preventing the gas from flowing from the tube to the outer tank.

16. The emergency release device of claim 14, wherein the outer tank includes:
a housing tank configured to accommodate the molten salt tank and shield radiation emitted from the molten salt contained in the molten salt tank; and
a gas storage tank that contains the gas.

17. The emergency release device of claim 14, wherein in the outer tank, a plurality of gas storage spaces are formed to contain the gas, and the plurality of gas storage spaces are independently partitioned not to communicate with each other in the outer tank.

18. An emergency release structure comprising:
a ship including a hull and a ballast tank disposed inside the hull;
a reactor unit disposed inside the hull and including a reactor vessel in which molten salt flows; and
an emergency release device for discharging molten salt discharged from the reactor vessel to an outside of the ship in an abnormal state where a temperature of the reactor vessel is outside in a predetermined range,
wherein the emergency release device includes:
a release assembly configured to receive the molten salt; and
a valve assembly configured to allow the molten salt to flow from the reactor vessel into the release assembly in the abnormal state and to be connected to the release assembly while the molten salt flows into the release assembly.

19. Then emergency release structure of claim 18, wherein the release assembly is disposed in the ballast tank.

20. The emergency release structure of claim 18, wherein the release assembly includes a molten salt tank whose interior is maintained in a vacuum state in a normal state where the temperature of the reactor vessel is controlled within the predetermined range, and is filled with the molten salt introduced from the reactor vessel through the valve assembly in the abnormal state, and
wherein the reactor unit further includes:
a discharge channel that provides a path for the molten salt to flow from the reactor vessel to the valve assembly; and
a discharge valve disposed in the discharge channel and opened or closed to allow or block the flow of the molten salt within the discharge channel.
